(19) United States
(12) Patent Application Publication
(10) Pub. No.: US 2007/0256670 A1
(43) Pub. Date: Nov. 8, 2007

(54) Integrated vacuum blocking valve

(75) Inventor: Benjamin Dominick Manton Williams, Chatham (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Canada Limited, Chatham (CA)

(21) Appl. No.: 11/797,441

(22) Filed: May 3, 2007

Related U.S. Application Data
(60) Provisional application No. 60/746,565, filed on May 5, 2006.

(51) Int. Cl. F02M 25/08; F02M 33/02

(52) U.S. Cl. 123/519

(57) ABSTRACT

A canister assembly (30) is provided for canister purge system of a vehicle. The assembly includes a canister (32) constructed and arranged to adsorb hydrocarbon vapor. A vapor blocking valve (34) is integral with the canister and is in fluid communication therewith. The vapor blocking valve has a port (42) constructed and arranged to fluidly communicate with a fuel tank of the vehicle. The vapor blocking valve is constructed and arranged to permit communication between the fuel tank and canister and, under certain conditions, to isolate the fuel tank from the canister. Since the vapor blocking valve is integral with the canister, additional hoses and mounting brackets are not required.

This application claims the benefit of the earlier filing date of U.S. Provisional Application No. 60/746,565, filed on May 5, 2006, which is incorporated by reference herein in its entirety.

### FIELD OF THE INVENTION

This invention relates to a vehicle canister purge system and, more particularly, to a blocking valve made integral with a carbon canister.

### BACKGROUND OF THE INVENTION

Charcoal vapor canisters attached in series to a vehicle's fuel storage system are used to adsorb hydrocarbon vapor produced in the fuel storage system in engine-off conditions. With reference to FIG. 1, during engine-on vehicle operations, air enters a canister purge system 10 through a canister vent valve 12, purges any fuel vapor trapped within the canister 14, and proceeds to purge line 16. Meanwhile, fuel vapor exits the fuel tank 18 through a vent valve 20 via line 22 and through a vapor blocking valve 24 into the purge line 16. This air/vapor mixture then enters the cylinder head of an engine for combustion through a purge control valve 17, as a supplement to the liquid fuel provided by the fuel system (injectors, carburetor) in a method well known in the art.

The vapor blocking valve 24 is used to limit the amount of vacuum applied to the fuel tank 18 within the vehicle canister purge system 10. This increases the predictability of the purge flow fuel vapor content and reduces the vapor generation rate within the fuel tank. The vapor blocking valve 24 is a normally open, on/off valve located between the fuel tank 18 and the canister 14. The valve 24 allows fuel vapors to be collected in the carbon canister 14 from the fuel tank 18 when the vehicle is parked, during re-fueling, and in use. The valve 24 is activated (closed) to isolate the fuel tank 18 from the engine manifold vacuum while the vehicle is purging the canister 14, through the purge line 16.

Since the valve 24 is coupled between the canister 14 and fuel tank, additional brackets, connectors and hoses are required for such coupling.

Thus, there is a need to integrate the vapor purge valve with a canister to reduce the number of parts and thus the cost of a canister purge system.

### SUMMARY OF THE INVENTION

An object of the invention is to fulfill the need referred to above. In accordance with the principles of the present invention, this objective is achieved by providing a canister assembly for canister purge system of a vehicle. The assembly includes a canister constructed and arranged to adsorb hydrocarbon vapor. A vapor blocking valve is integral with the canister and is in fluid communication therewith. The vapor blocking valve has a port constructed and arranged to fluidly communicate with a fuel tank of the vehicle. The vapor blocking valve is constructed and arranged to permit communication between the fuel tank and canister and, under certain conditions, to isolate the fuel tank from the canister. Since the vapor blocking valve is integral with the canister, additional hoses and mounting brackets are not required.

In accordance with yet another aspect of the invention, a method of mounting a vapor blocking valve is provided. The method provides a canister constructed and arranged to adsorb hydrocarbon associated with a vehicle. A vapor blocking valve is mounted directly to the canister. The vapor blocking valve has a port constructed and arranged to fluidly communicate with a fuel tank of the vehicle. The vapor blocking valve is constructed and arranged to permit communication between the fuel tank and canister and, under certain conditions, to isolate the fuel tank from the canister.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings wherein like numbers indicate like parts, in which:

FIG. 1 is a schematic view of a conventional canister purge system showing a vapor blocking valve separate from a canister.

FIG. 2 is a view of the carbon canister assembly including an integral vapor blocking valve in accordance with a first embodiment of the invention.

FIG. 3 is a view of the carbon canister assembly including an integral vapor blocking valve in accordance with a second embodiment of the invention.

### DETAILED DESCRIPTION OF THE EXEMPLARY EMBODIMENTS

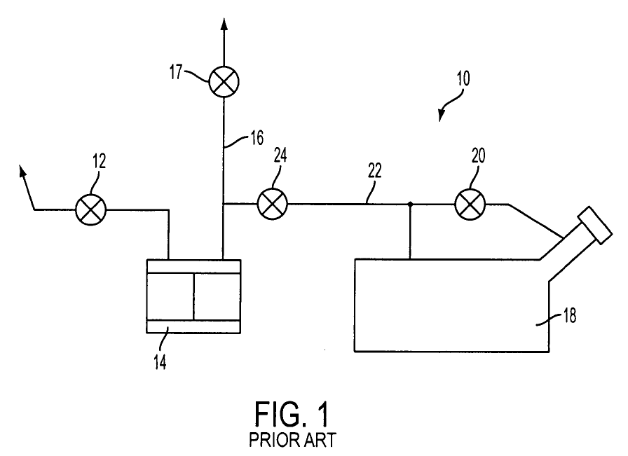

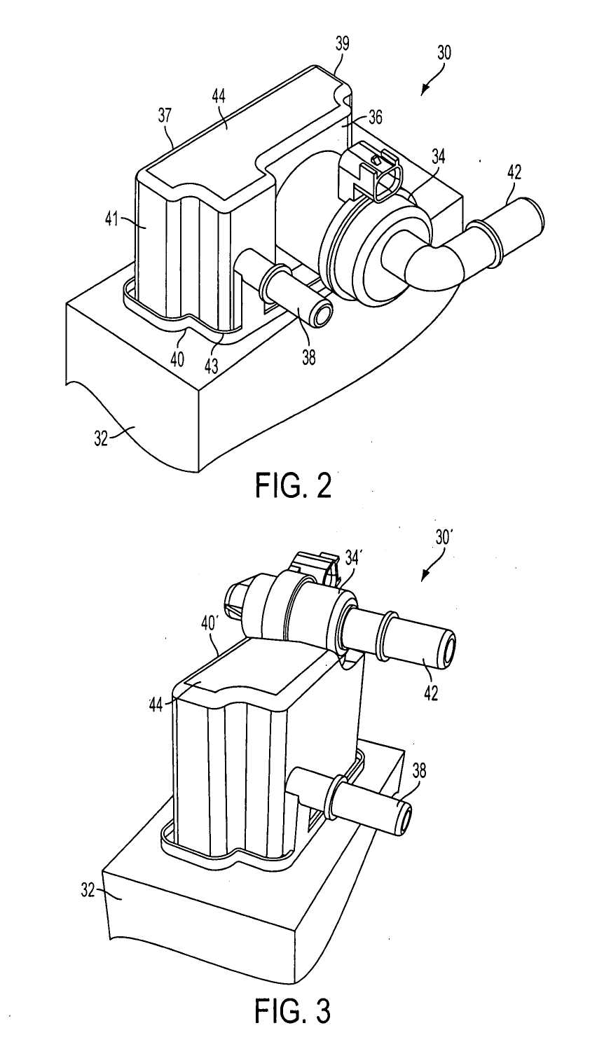

With reference to FIG. 2, a first embodiment of a carbon canister assembly is shown, generally indicated at 30 for use in a vehicle canister purge system of the type shown in FIG. 1. The assembly 30 includes a canister cap 40 and canister 32, and an integral vapor blocking valve 34 mounted directly to a front 36 of the canister cap 40 and in fluid communication with the canister 32. The canister cap 40 has a front 36, a back 37, sides 39 and 41, a top 44 and a bottom 43 is attached to the canister 32. The canister cap 40 can be considered to be part of the canister 32. The canister 32 contains carbon in the conventional manner to adsorb hydrocarbon vapor produced in a fuel storage system of a vehicle in engine-off conditions. The canister cap 40 includes a port 38 that is constructed and arranged to fluidly communicate with a canister vent valve (not shown) for purging any fuel vapor trapped within the canister 32. The cap 40 is welded to a top of the canister 32 to close an opening in the canister 32.

The vapor blocking valve 34 is a normally open, on/off valve that fluidly connects or isolates a fuel tank (not shown) from the canister assembly 30 via port 42. The vapor blocking valve 34 allows fuel vapors to be collected in the canister 32 from the fuel tank when the vehicle is parked, during re-fueling, and in use. The vapor blocking valve 34 is activated (closed) to isolate the fuel tank from the engine manifold vacuum while the vehicle is purging the canister 32.

With reference to FIG. 3, a second embodiment of a carbon canister assembly is shown, generally indicated at 30′. The assembly 30′ includes a canister 32, a canister cap 40′, and an integral vapor blocking valve 34′ mounted directly to a top 44 of the canister cap 40′. The canister cap 40′ includes the port 38. The vapor blocking valve 34′ includes the port 42 that is constructed and arranged to fluidly communicate with a vehicle fuel tank (not shown) and operate in the manner discussed above.

The vapor blocking valve 34, 34′ can have a housing that is molded with the canister cap 40, 40′ or can be attached directly thereto in any known manner. Since the vapor blocking valve 34, 34′ is integral with the canister assembly 30, there is no need for an extra hose between the canister and vapor blocking valve, nor is there a need to provide an additional mounting bracket to mount the vapor blocking valve. Thus, costs are reduced.

Both of the configurations shown in FIGS. 2 and 3 maintain an internal reservoir volume within the canister assembly 30, protecting the canister from exposure to liquid fluid.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A canister assembly for canister purge system of a vehicle, the assembly comprising:
a canister constructed and arranged to adsorb hydrocarbon vapor, and
a vapor blocking valve integral with the canister and in fluid communication therewith, the vapor blocking valve having a port constructed and arranged to fluidly communicate with a fuel tank of the vehicle, the vapor blocking valve being constructed and arranged to permit communication between the fuel tank and canister and, under certain conditions, to isolate the fuel tank from the canister.

2. The assembly of claim 1, wherein the canister includes a canister cap, the vapor blocking valve being integral with the canister cap.

3. The assembly of claim 2, wherein the canister cap has a top, a bottom, a front, a back, and sides.

4. The assembly of claim 3, wherein the vapor blocking valve is mounted directly to the top of the canister cap.

5. The assembly of claim 3, wherein the vapor blocking valve is mounted directly to the front of the canister cap.

6. A canister assembly for canister purge system of a vehicle, the assembly comprising:
a means for adsorbing hydrocarbon vapor, and
means, integral with and in fluid communication with the means for adsorbing, for blocking vapor, the means for blocking vapor being constructed and arranged to fluidly communicate with a fuel tank of the vehicle, the means for blocking vapor being constructed and arranged to permit communication between the fuel tank and means for adsorbing and, under certain conditions, to isolate the fuel tank from the canister.

7. The assembly of claim 6, wherein the means for adsorbing has a top, a bottom, a front, a back, and sides.

8. The assembly of claim 6, wherein the means for blocking vapor is a valve mounted directly to the top of the means for adsorbing.

9. The assembly of claim 6, wherein the means for blocking vapor is a valve mounted directly to the front of the means for adsorbing.

10. The assembly of claim 7, wherein the means for adsorbing is a canister including a canister cap and wherein the means for blocking vapor is a valve mounted directly the canister cap.

11. A method of mounting a vapor blocking valve comprising:
providing a canister constructed arranged to adsorb hydrocarbon associated with a vehicle, and
mounting a vapor blocking valve directly to the canister, the vapor blocking valve having a port constructed and arranged to fluidly communicate with a fuel tank of the vehicle, the vapor blocking valve being constructed and arranged to permit communication between the fuel tank and canister and, under certain conditions, to isolate the fuel tank from the canister.

12. The method of claim 11, wherein step of providing a canister includes providing a canister including a canister cap having a top, a bottom, a front, a back, and sides.

13. The method of claim 12, wherein the step of mounting includes mounting the vapor blocking valve directly to the top of the canister cap.

14. The method of claim 12, wherein the step of mounting includes mounting the vapor blocking valve directly to the front of the canister cap.
